(19) United States
(12) Patent Application Publication
(10) Pub. No.: US 2009/0018917 A1
(43) Pub. Date: Jan. 15, 2009

(54) PLATFORM FOR ADVERTISEMENT REFERRALS FOR AUTHORS OF VIDEO CONTENT

(75) Inventors: Brent Chapman, Vancouver (CA); Ian James Corlett, Vancouver (CA)

Correspondence Address: DARBY & DARBY P.C., P.O. BOX 770, Church Street Station, New York, NY, 10008-0770, US

(73) Assignee: Brent Chapman, Vancouver (CA)

(21) Appl. No.: 12/172,149

(22) Filed: Jul. 11, 2008

Related U.S. Application Data
(60) Provisional application No. 60/949,795, filed on Jul. 13, 2007.

(51) Int. Cl. G06Q 10/00; G06Q 30/00

(52) U.S. Cl. 705/14

(57) ABSTRACT

Advertisements are combined with content, such as videos, in accordance with criteria provided by advertisers and content owners. Advertisers upload advertisement(s) for publication with content. Content owners upload content and select advertisers and/or advertisement(s) for sponsorship consideration. Advertisers review the content and decide whether or not to approve the advertisement/content combination. In one embodiment, a fast track pre-approval process may be used by advertisers for selected content owners. Upon approval, advertisement(s) are combined with the content and the combined content is made available for publication to an online audience. A portion of the revenue generated by the publication of the combined content is provided to the content owner. In addition, the size of the portion of revenue may be based on a sponsorship level, or the type of advertisement(s) combined with the content.

### CROSS-REFERENCE TO RELATED APPLICATION

This application is a utility patent application based on a previously filed U.S. Provisional Patent Application, Ser. No. 60/949,795 filed on Jul. 13, 2007, the benefit of which is hereby claimed under 35 U.S.C. §119(e) and is further incorporated herein by reference.

### TECHNICAL FIELD

The present invention generally relates to online advertising, and in particular, but not exclusively, to a platform for combining advertisements with content and for providing revenue to content owners.

### BACKGROUND

Online advertising is a fast-paced multi-billion dollar industry. Advertisements may be employed to increase brand recognition, improve sales, and as integral parts of public relations campaigns. In the advertising industry, the advantages of presenting advertisements to large and/or targeted audiences are well recognized.

Further, the production, sharing, and online viewing of content are very popular. In fact, many content sharing websites have been developed and have grown rapidly. In certain cases, content sharing websites companies have been valued at over a billion dollars. Online videos are one example of content that has experienced a rapid rise in popularity. Currently, millions of videos are viewed online every day and certain videos may be watched by an audience of millions.

Although the popularity of viewing content online presents a unique advertising opportunity, the commercialization of this content and particularly online videos, it is accepted by industry experts that it still is in its infancy.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows a functional block diagram illustrating one embodiment of an environment for practicing the invention;

FIG. 2 shows one embodiment of a mobile device useable as a client device within the environment of FIG. 1;

FIG. 3 shows one embodiment of a network device useable as an advertisement server, content server, management server, or website server within the environment of FIG. 1;

FIG. 4 illustrates a logical flow diagram generally showing one embodiment of a process useable to enable content owners to combine content with advertisements for revenue;

FIG. 5 illustrates a logical flow diagram generally showing one embodiment of a process for providing a portion of revenue for publication to a content owner;

FIG. 6 illustrates a logical flow diagram generally showing an embodiment of another process useable to solicit bids for content from advertisers;

FIG. 7 is a screenshot depicting an embodiment of a webpage for practicing the present invention;

FIG. 8 is a screenshot depicting an embodiment of an advertiser interface;

FIG. 9 is a screenshot depicting an embodiment of a content owner interface; and

FIG. 10 is a screenshot depicting an embodiment of an audience interface.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, processes, or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the phrase “click thru” reviews to a process where a computer user moves the a user input device, such as a mouse, computer display cursor, or the like, over a specified symbol, icon, widget, or the like, displayed on the computer screen and selects the symbol, icon, widget, or the like. In one embodiment, such selection may be performed through the user input device. The selection results in redirecting the user's display to another display. When typical implementation of click thru, is within a user's web browser, where selecting a displayed symbol results in being redirected to a different web page, which may be identified through a link associated with the selected symbol.

As used here, the terms “content provider” or “content owner” mean any entity that creates and/or otherwise provides content, such as a video, or other digital content, including multimedia content, for internet use. The content provider is also referred to as the “content owner.”

The term “videos” refers to any form of content that includes at least a video component displayable over a network. As such, the videos may include multimedia content that may include, but is not limited to audio/videos, movies, music videos, animation, graphics, or the like. Moreover videos may be either captured, candid events, or scripted stories, without departing from the scope of the invention. The invention, however, is not limited to videos, however, and virtually any digital content may be considered, including, but not limited to audios, text files, such as blog articles, commentaries, news articles, or the like.

The term “watermark” refers to any image, pattern, or other identifier that may be embedded into content, and is useable to identify a characteristic of the content, such as a source of the content, a quality of the content, owner of the content, or the like. In one embodiment, a watermark may include a trademark, logo, or the like. In one embodiment, the watermark may be configured to operate as a security mechanism that can identify the internet source of the content. In one embodiment, the watermark may be arranged such that once it is embedded into the content, it cannot readily be removed.

Briefly stated embodiments of the invention are directed towards sponsoring and combining advertisements with content provided in a form of amateur online videos in accordance with criteria provided by advertisers as well as content owners. Advertisers upload brief branding sequence(s) or advertisements for use before the start and/or at the end of the video. In one embodiment, the advertisement segments are configured to be relatively short in a play length, so as to minimize a likelihood of being ignored by a viewer. In one embodiment, the advertisement segments might be configured to be less than about two seconds in play length, although other play lengths may be selected, without departing from the scope of the invention.

The advertising segments at the end of a video may include an advertiser's click thru to give a prospective viewer an opportunity to be directed to a promotional site. In one embodiment, a discreet yet prominent logo or message in the form of a transparent watermark, or other symbol, may be visible in a corner of the viewing screen for the duration of the video. In one embodiment, the watermark, or other symbol, might uniquely identify the advertiser for which the advertisement is associated.

Content providers may connect to a provided website, select an advertiser, and upload their video. Videos and advertisement elements may then be combined automatically. The new video, complete with advertising elements attached, is subjected to the advertiser's review for content approval. In one configuration, a completed video cannot be distributed immediately, but can be reviewed by content providers. The approval process can be streamlined based on an online community reputation a content provider has developed based in part, for example, on a positive track record of creating videos that are appropriate and attract attention. In another embodiment, the reputation of the content provider may also be based on a rating by a plurality of advertisers. Such additional ratings may then be combined with viewer reputation and/or employed separately. In one embodiment the reputation of the content provider might be used to fast track or pre-approve selected content providers. That is, a pre-approved content provider's content might not have to be reviewed and approved each time. Instead, based on the content provider's reputation rating(s), the content might be fast tracked and be pre-approved.

Upon approval, the combined video and advertising elements, is made available to an online audience. Fees for attachment to the videos are paid by advertisers based on a variety of criteria, including, but not limited to a number of views, length of views, a number of click thrus, or the like. A portion of these revenues may be paid to the content provider. Content providers may even offer their productions up for bid and allow advertisers the opportunity to screen their work and vie to be associated with specific videos.

In one embodiment, selected advertisers may employ a community type of control mechanism for monitoring a quality of content, a popularity of content, or the like. For example, in one implementation, an advertiser might participate in a group of advertisers that might agree to not review/approve content before it is combined with advertisements and published for public consumption. In one embodiment, the group of advertisers might agree to have their brands protected through a variety of mechanisms, including, for example, where viewers' input is used to identify inappropriate content that should be removed from display. In another embodiment, the content owner might farther agree to voluntarily maintain a level of quality of submitted content, thereby, enabling the content owner to be initially pre-approved for fast tracking. Content owners that fail to meet a code of content based on viewers' input, their voluntary agreements, and/or advertisers' input, may be prohibited from submitting content for review/publication with advertisements from a given advertiser, and/or lose fast tracking opportunities.

As may be readily recognized, the present invention thus encourages and facilitates relationships between advertisers and content providers. Through the invention as described in more detail below, content providers are provided opportunities of selecting advertiser/advertisements with which to associate their content, providing the content owners a freedom of building relationships. Advertisers are also provided opportunities to select from content and/or content providers that have previously established a reputation, thereby saving the advertisers unnecessary guessing of content quality. Moreover, advertisers and content providers may, together, create a fast-tracking approach where quality content providers may quickly select which advertisers/advertisements to associate their content with.

It should be noted that other embodiments are also envisaged. For example, in one embodiment, based on content providers reputation, or the like, an advertiser may approach a given content provider and request and/or commission content for association with an advertisement. Thus, the invention further enables content providers opportunities to generate revenue based on their reputation.

### Illustrative Operating Environment

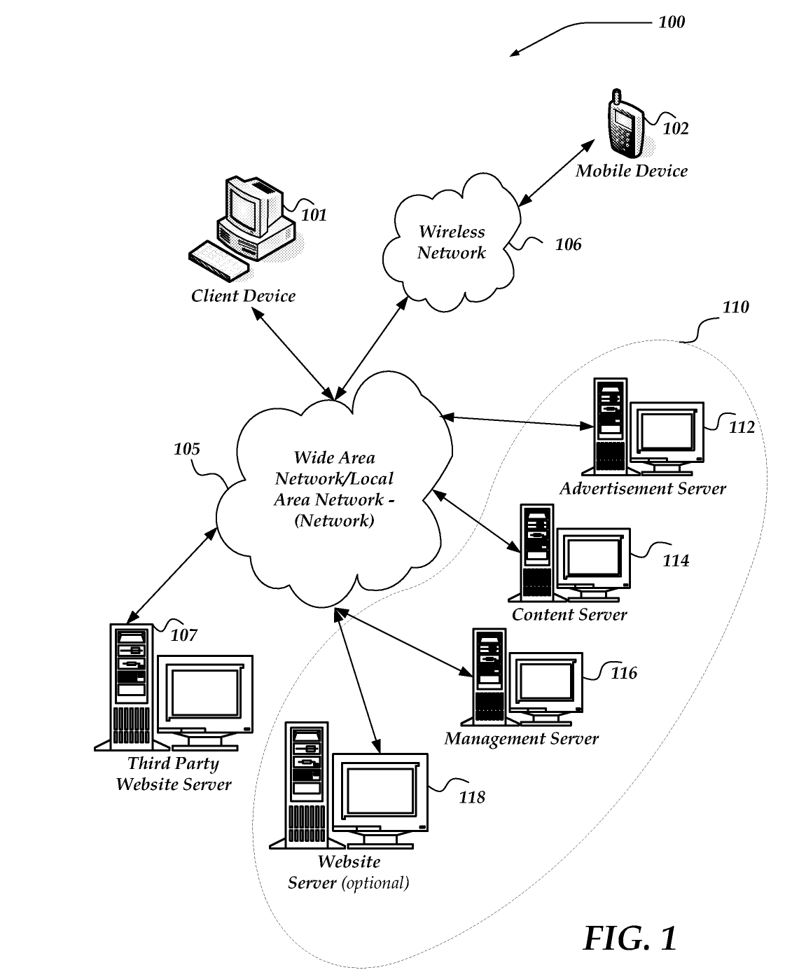

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 106, third party website server 107, platform 110, advertisement server 112, content server 114, management server 116, website server 118, mobile (wireless) device 102, and client device 101.

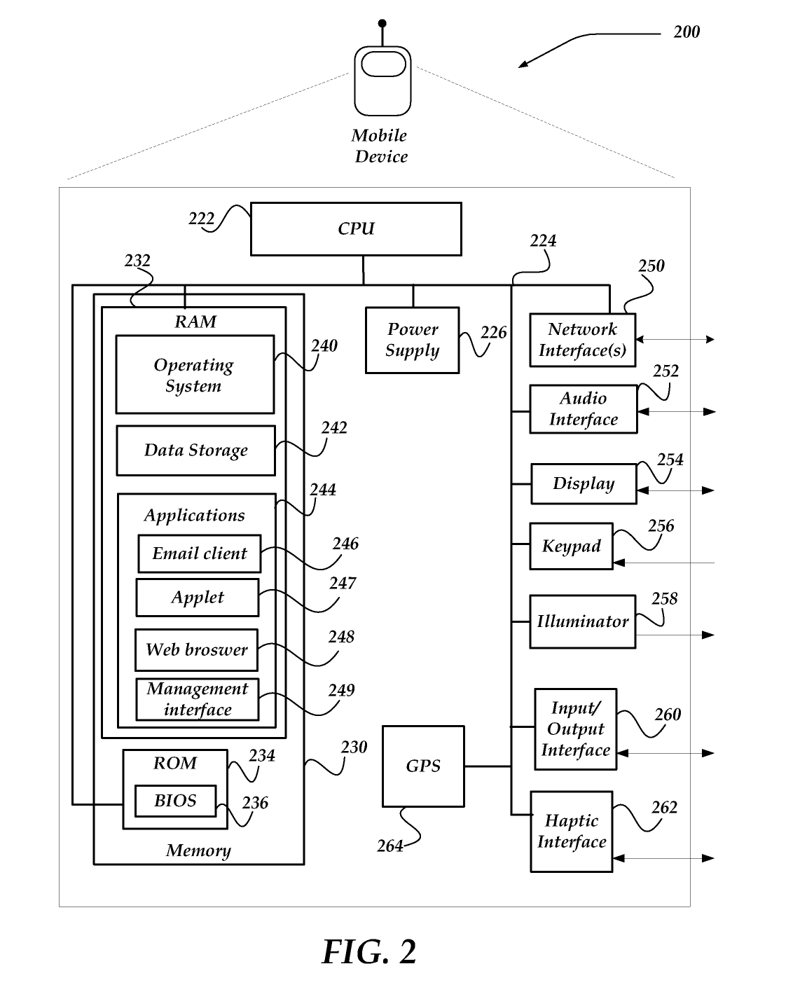

One embodiment of mobile device 102 is described in more detail below in conjunction with FIG. 2. Generally, however, mobile device 102 may include virtually any portable computing device capable of receiving and sending a message over a network, such as network 105, wireless network 106, or the like. Mobile device 102 may also be described generally as client devices that are configured to be portable. Thus, mobile device 102 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. As such, mobile device 102 typically ranges widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

Mobile device 102 may further be configured to include a client application that enables a user, such as an advertiser, content owner, audience member, and/or the like, to interact with platform 110 and/or to interact with the content published by platform 110. Additionally, mobile device 102 may also communicate with non-mobile (wired) client devices, such as client device 101, or the like.

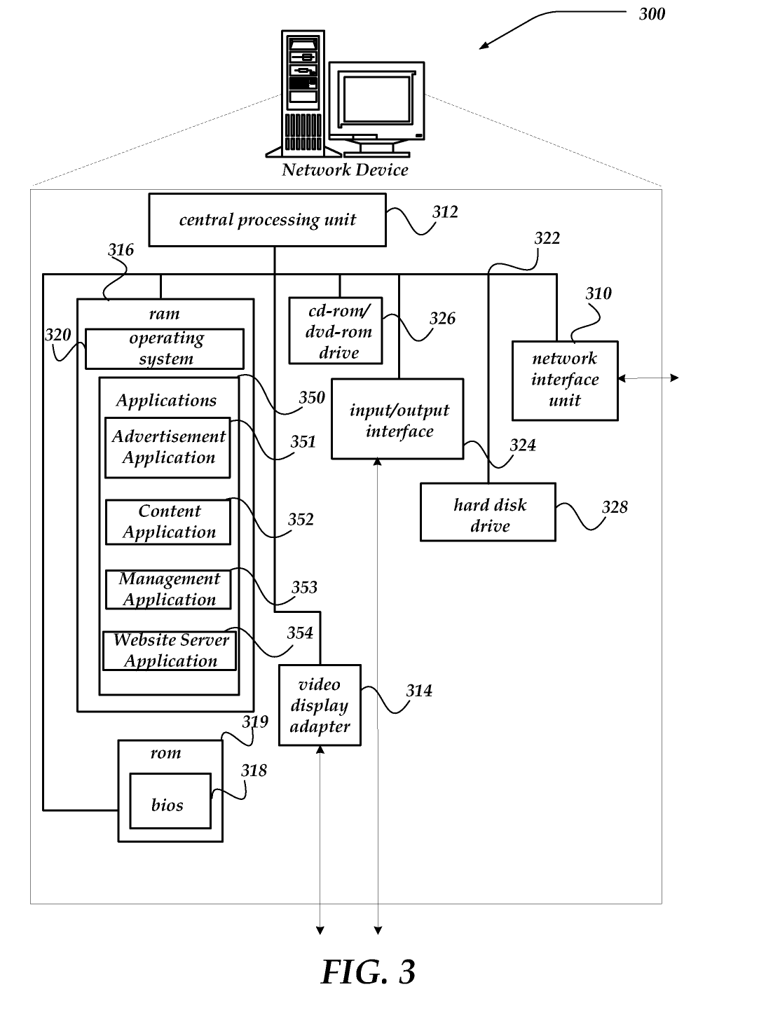

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Wireless network 106 is configured to couple mobile device 102 and its components with communication provided over network 105. Wireless network 106 may include any of a variety of wireless sub-networks that may further overlay stand-alone ad-hoc networks, and the like, to provide an infrastructure-oriented connection for mobile device 102. Such sub-networks may include mesh networks, Wireless LAN (WLAN) networks, cellular networks, and the like.

Wireless network 106 may further employ a plurality of access technologies including 2nd (2G), 3rd (3G), and 4th (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile device 102 with various degrees of mobility. For example, wireless network 106 may enable a radio connection through a radio network access such as Global System for Mobile communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 106 may include virtually any wireless communication mechanism by which information may travel between mobile device 102 and another computing device, network, and the like.

Network 105 is configured to couple platform 110 and its network devices with other computing devices, including, client device 101, and through wireless network 106 to mobile device 102. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 110, client device 101, mobile device 102, third party website server 107, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Although FIG. 1 illustrates platform 110 including advertisement server 112, content server 114, management server 116, and website server 118, as physically separate network devices, the invention is not so limited. For example, one or all of the servers can be operated on one network device, without departing from the scope or spirit of the present invention. Also, devices that may operate as platform 110 include personal computers desktop computers, multiprocessor systems, microprocessor-based or programmable consumer electronics, network PCs, servers, and the like.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile device 102 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 236 for controlling low-level operation of mobile device 200. The mass memory also stores an operating system 240 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 242, which can be utilized by mobile device 200 to store, among other things, applications 244 and/or other data. For example, data storage 242 may also be employed to store information that describes various capabilities of mobile device 200. The information may then be provided to another device based on any of a variety of events, including being sent as part of a header during a communication, sent upon request, or the like.

Applications 244 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, video games, gaming programs, search programs, shopping cart programs, and so forth. Applications 242 may further include web browser 248. The web browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Web browser 248 may be configured to enable a display of rendered content provided by platform 110. Further, web browser 248 enables the user of mobile device 200 to select different actions displayed by the rendered content. In at least one embodiment, web browser 248 enables the user to select one or more of a product to purchase, search for content and display the result, call another telephonic device, display and respond to messages, interact with platform 110, interact with content published by platform 110, or the like.

Applications 242 may further include email client 246, applet 247, and management interface 249. The email client application may be configured to receive email notifications from the platform 110. The email client may be a widely available email client such as MICROSOFT Outlook, Eudora, or the like, or may be part of web browser 248. In this case, a user may access email through a web mail interface within web browser 248. Management interface 249 may be a small applet or widget providing notifications from platform 110.

### Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, third party website server 107, advertisement server 112, content server 114, management server 116, website server 118, and/or client device 101 of FIG. 1.

Network device 300 includes processing unit 312, video display adapter 314, and a mass memory, all in communication with each other via bus 322. The mass memory generally includes RAM 316, ROM 319, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also may communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth.

Advertisement server 352, content server 354, management server 356, and website server 358 may also be included as application programs within applications 350. For example, an advertisement server network device 112 may include an advertisement server application 352. Also, advertisement server application 352, content server application 354, management server application 356, and website server application 358, may be configured as a platform for providing a portion of revenue for publication of an advertisement/content combination to a content owner.

### Generalized Operation

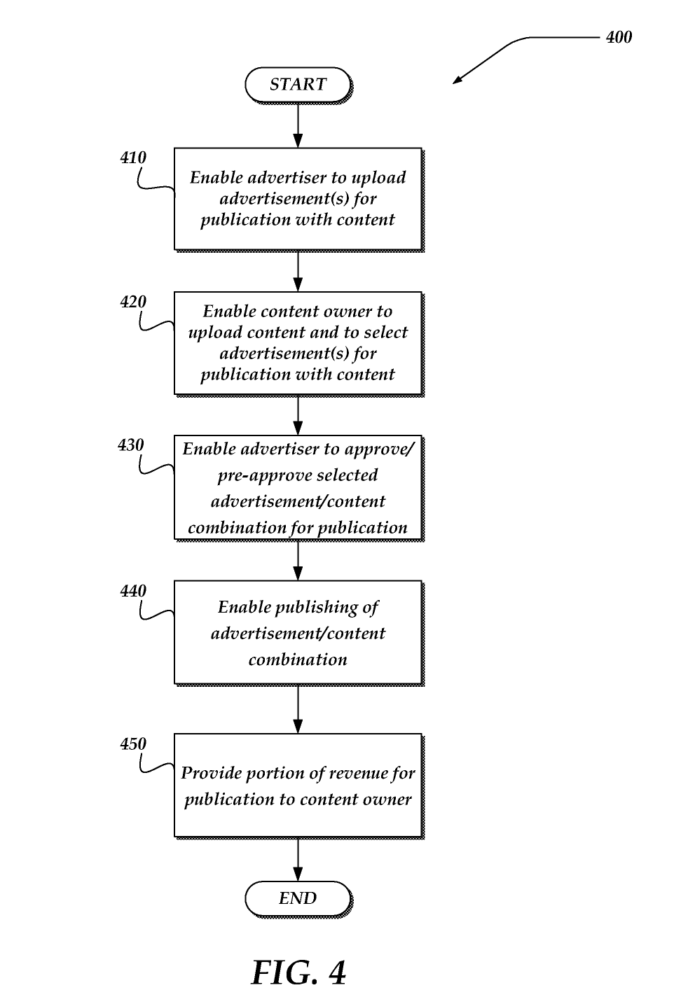

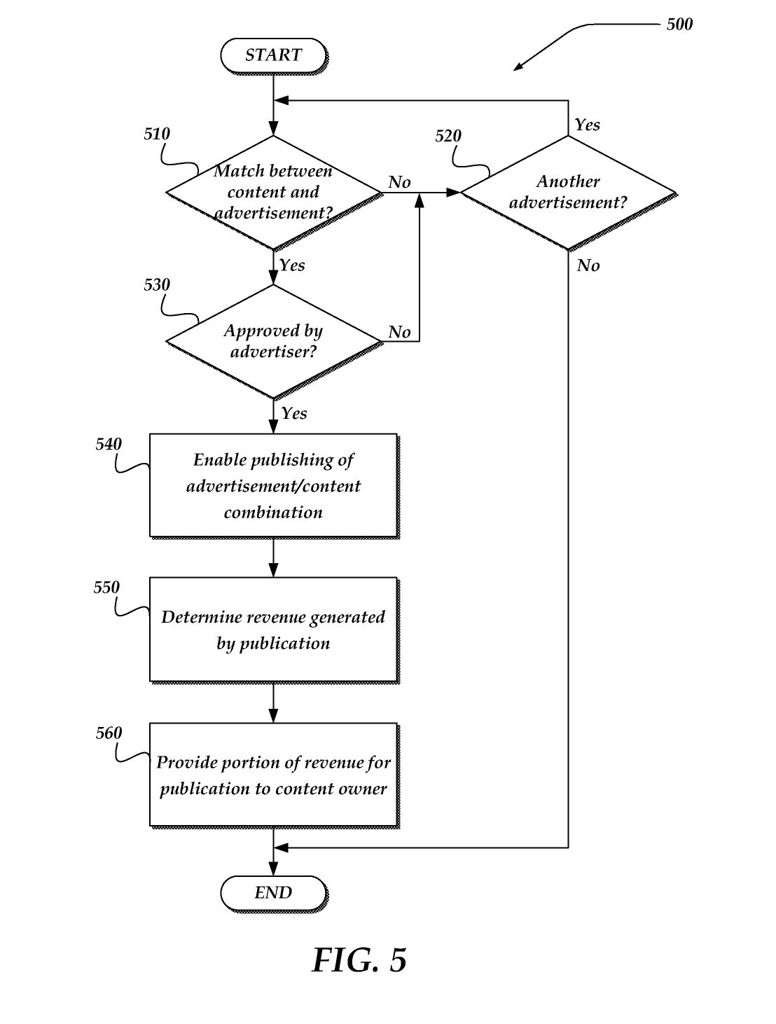

The operation of certain aspects of the invention will now be described with respect to FIGS. 4-5. FIG. 4 illustrates a logical flow diagram generally showing one embodiment of process 400 by which the invention may be practiced.

As shown, process 400 begins, after a start block, at block 410, where an advertiser is enabled to upload advertisement(s) for publication with content. For example, advertisements which may be uploaded include an advertiser's name, slogan, logo, text, message, sound, animation, video, and/or the like, and combinations thereof. Advertisements may also include an advertiser's trademark(s) and/or service mark(s). Further, advertisements may be of any size or duration. For example, relatively short “bookend” advertisement(s) that include an advertiser's logo and sound may be uploaded as one advertisement. Such bookend advertisements may be placed before and/or after the content as discussed below. In one embodiment, bookend advertisements may be shorter than approximately two seconds and are relatively unobtrusive. Also, advertisements may further include watermarks, overlays, and/or the like. In at least one embodiment, advertisements include mouse-over advertisements, click-through advertisements, interactive games, short surveys, and/or the like. These and other advertisements are within the spirit and scope of the invention.

In at least one embodiment, advertisements may be provided in, or converted to, Flash file format. However, advertisements may be provided in, or converted to, any suitable file format which can be employed for advertisements. For example, the Free Software Foundation's Gnash file format, the W3C's Scalable Vector Graphics file format, ActionScript script files, and the like, can be employed with at least one embodiment of the invention.

At block 410, an advertiser may also provide criteria to platform 110 to indicate the type of content that the advertiser seeks to publish an advertisement with. For example, the advertiser may specify a desired length of content, subject matter (e.g., comical content, educational content, sports content, etc.). Further, the advertiser may provide information about the advertisement. For example, the advertiser may describe the advertisement, may indicate the length of the advertisement, whether it is a bookend advertisement, an overlay advertisement, and/or the like. In one embodiment, the platform 110 automatically determines at least one of the above described criteria.

In one embodiment, an advertisement server, such as advertisement server 112 of FIG. 1, and an advertisement server application, such as advertisement server application 352 of FIG. 3, may be employed to enable, in part, an advertiser to upload advertisement(s) for publication with content. However, other network devices and applications may also be suitably employed.

Processing then moves to block 420, where a content owner is enabled to upload content and to select advertisement(s) for publication with content. For example, content may include video clips, audio clips, animations, photographs, games, and/or the like. In one embodiment, a platform, such as platform 110 of FIG. 1, enables the upload of video clips such as home video clips, outtakes, music videos, video commentaries, educational videos, and/or the like. However, the invention is not limited to this embodiment. Virtually any type of content can be uploaded by a content owner, such as a content author, an owner of online use rights, a copyright owner, one who commissioned the creation of the content, and/or the like.

In one embodiment, a content server, such as content server 114 of FIG. 1, and a content server application, such as content server application 354 of FIG. 3, may be employed to enable, in part, a content owner to upload content and to select advertisementfs) for publication with content. However, other network devices and applications may also be suitably employed.

Further, a content owner may select advertisement(s) for publication with content. For example, a content owner may view advertisement(s) that have been uploaded at block 410 and select certain advertisement(s) to be combined (upon advertiser approval) with the content. A content server and/or content server application may also include an interface to browse, search, and/or select advertisement(s). For example, a content owner may search advertisements based on criteria such as advertisement duration, type (bookend, overlay, etc.), market segment, sponsorship terms, and/or the like. In one embodiment, a content owner selects multiple advertisements and ranks them in order of preference. In one embodiment, after an advertisement is selected, the content is submitted to the advertiser for sponsorship consideration and review. In one embodiment, the selection of advertisements may include recommendations of suggested advertisements or advertisers, automatic selection, random selection, and/or the like. These and other methods of selection may be employed.

Further, a content owner may select between advertisers that are grouped into multiple levels. In one embodiment, advertisers within a level each preferably offer the same sponsorship terms for publication of an advertisement/content combination. For example, a “gold” level advertiser would pay more than a “bronze” level advertiser, but could receive additional advertising time, preferential selection of content for sponsorship, preferential promotion of the advertisement, and/or the like. In one embodiment, “Bronze” level advertisers might pay less but would not have the option to decline videos unless they are deemed inappropriate by the site manager.

At block 420, a content owner may also provide criteria to platform 110 to indicate the type of advertisements that the content owner seeks to publish the content with. The content provider may have created or capture content that may match a general or specific theme of the advertisers. For example, the content owner may specify a desired length of advertisement, sponsorship terms, type of advertisement, market segment (e.g., pharmaceutical, automobile, restaurants, etc.). Further, the content owner may provide additional information about the content. For example, the content owner may provide a written description of the content, indicate the length of the content, indicate the author, and/or the like. In one embodiment, the platform 110 automatically determines at least one of the above described criteria.

At block 420, the content owner selects one or more advertisements with which to associate their content. In this manner, the content provider is provided a degree of ‘freedom of association’ that enables them to make decisions, rather than have such selections performed automatically and independent of a content owner's preferences, likes, dislikes, or the like.

At block 430, an advertiser is also enabled to approve selected advertisement/content combination for publication. In one embodiment, an advertiser is notified when a content owner selects the advertiser's advertisement for potential publication in combination with the content owner's content. Notification may be in the form of an email message, text message, SMS message, instant message, MMS message, voice mail, and/or the like. However, the invention is not limited to this embodiment and other types of notifications may be used. For examples, notifications may be provided in the form of an alert. The user may install a management interface application such as management interface 249 described in conjunction with FIG. 2. The platform may notify the management interface application of a content owner's selection. The management interface application may then provide an alert to the contact in the form of a sound, pop up, notifier, and/or the like. The sound, pop up, notifier, and/or the like may include a message regarding the content.

Approval may include manual advertiser approval, automatic approval, be controlled by advertiser defined rules, and/or the like. For example, an advertiser may desire to manually review and approve each potential publication of each advertisement/content combination. However, other advertisers may wish to automatically approve all potential publications, automatically approve publication of their advertisements in combination with content from “trusted” content owners, automatically approve publication of advertisements with content targeted to certain demographics or containing certain subject matter (e.g., family oriented, teen oriented, automobile videos, educational content, etc.), automatically approve publication if no manual action is taken within a defined time period, and/or the like.

In one embodiment, a mechanism might be implemented that is useable to rate content providers based on a variety of criteria. For example, content providers might be rated based on viewer comments of the type of content the content provider provides, or virtually any other metric/measure. The content provider might then build a reputation or the like that might be based on a code of content for the viewing community. As content providers build a rating, the rating may then be used by advertisers to determine whether to pre-approve content from a content provider, refuse pre-approval, or even to refuse to evaluate or otherwise be associated with a given content provider. In one embodiment the ratings may be generated based on a weighting of viewers' inputs.

In another embodiment, a plurality of advertisers may provide ratings on content and/or content providers. Such ratings may then be used to subsequently pre-approve a content provider. In one embodiment, the ratings of the viewing community and the ratings of the plurality of advertisers may be combined using any of a variety of weightings. For example, in one embodiment, advertiser ratings might be rated higher than viewer ratings; although, in another embodiment, viewer ratings might be rating higher than advertiser ratings; and in still another embodiment, the ratings from advertisers and viewers might be weighted the same. However, other weighting schemes may also be used. In any event, such pre-approvals are directed toward enabling a content provider to fast track subsequent content and getting ahead of other content providers in terms of exposure, financial opportunities, or the like.

In at least one embodiment, if an advertiser does not approve publication of the advertisement with the submitted content, the content is further submitted to other advertisers. In addition, methods, such as a bidding method, may be employed to enable advertisers to bid on content be published with their advertisement Further, if no advertiser wishes to publish its advertisement with the content, the content may be published with the platform's advertisement, a third party advertisement, the content owner's advertisement, no advertisement, and/or the like. Further, the platform may enable post-publication changes to sponsorship. For example, the platform may enable either the content owner or the advertiser to cease publication of the advertisement/content combination, enable changes in advertisements and/or advertisers, change sponsorship levels, and/or the like.

In one embodiment, an advertisement server, such as advertisement server 112 of FIG. 1, and an advertisement server application, such as advertisement server application 352 of FIG. 3 may be employed to enable, in part, the performance of block 430. However, other network devices and applications may also be suitably employed.

At block 440, the publishing of an advertisement/content combination is enabled. For example, after an advertiser has approved the publication of an advertisement with the content, the advertisement is combined with content and published on a website server. In one embodiment, combination of the advertisement with the content, such as a video, includes the concatenation of bookend advertisements with the content. For example, bookend advertisements may be concatenated before and/or after the content. In addition, an advertisement may also be overlaid on the content. For example, overlaying may include placing the advertiser's logo in a corner of the content. For other content, such as audio, still photographs, and/or the like, the same and other advertisement types may be employed.

In one embodiment, an advertisement server, such as advertisement server 112 of FIG. 1, and an advertisement server application, such as advertisement server application 352 of FIG. 3 and/or a content server, such as content server 114 of FIG. 1, and a content server application, such as content server application 354 of FIG. 3 may be employed, to combine the advertisement with the content. However, other network devices and applications may also be suitably employed.

In one embodiment, the combination of the advertisement and the content is performed dynamically by platform 110. For example, the advertisements and the content may each be layers in Flash format and may be automatically combined to form an advertisement/content combination. However, any suitable technology and file formats may be employed. As discussed above, the Free Software Foundation's Gnash file format, the W3C's Scalable Vector Graphics file format, ActionScript script files, and related applications, can be employed to generate an advertisement/content combination. In at least one embodiment, a mechanism for manual oversight of advertisement/content combinations is provided.

After generating an advertisement/content combination, the advertisement/content combination may be published on the platform's website server 118, a third-party website server 107, and/or the like.

At block 450, a portion of the revenue for publication is provided to the content owner. In one embodiment, a management server, such as management server 116 of FIG. 1 or a management server application, such as management server application 356 of FIG. 3 tracks activity associated with the advertisement/content combination. Activity may be tracked based on a number of impressions (e.g., number of times the content is viewed, duration of viewing, repeated viewings, etc.), click-throughs, mouse-overs, submissions, transactions, follow-ups, and/or the like. Also, management server 116 may communicate with a website server such as website server 107 or 118 to track the activity associated with the advertisement/content combination. Website servers 107, 118, or management server 116 may employ cookies, log-file analysis, user login tracking, and/or the like, to track activity.

Platform 110 may then collect revenue from the advertiser. This revenue may be apportioned between platform 110, the content owner, third-party website server 107, and/or the like. In another embodiment, the content owner and/or third-party website server 107 may collect revenue from the advertisers and pay a percentage to platform 110. The portion paid to each party may be determined based on a predefined formula, predefined percentage, dynamically adjusted, and/or the like. Likewise, the invention is not limited to these examples and revenue may be apportioned in other ways. Regardless, process 400 may then return to a calling process to perform other actions.

FIG. 5 is illustrates a logical flow diagram generally showing one embodiment of a process for providing a portion of revenue for publication to a content owner. Process 500 of FIG. 5 may be employed as one embodiment of blocks 430-450 of FIG. 4. However, process 500 may include additional, different, or less functionality than blocks 430-450 of FIG. 4. In one embodiment, process 500 is performed by management server 116 of FIG. 1 and/or management server application 356 of FIG. 3.

In one embodiment, process 500 begins, after a start block, at block 510. At block 510, a determination is made regarding whether there is a match between a selected content and a selected advertisement. This determination may be based criteria provided or determined at blocks 410-420 of FIG. 4. For example, if a content owner has uploaded a video clip of a golfing event but the advertiser has specified that a particular advertisement is to be published with a cooking content then the content does not match the advertisement. Likewise, the block 510 determination may also be based upon criteria provided by the content owner. For example, if a content owner has specified that the content may be published with any bookend advertisement of two seconds or shorter, the content will match any bookend advertisement that two seconds or shorter.

If at block 510, the content does not match the advertisement, processing continues to block 520. At block 520, a determination is made regarding whether there is another advertisement which may potentially match the content. If so, processing returns to block 510 to determine if the other advertisement matches the content. If there are no remaining advertisements, then process 500 ends.

If at block 510, the content matches the advertisement, processing progresses to block 530 to ascertain if the content is approved by the advertiser. Approval may have been previously obtained, or may be obtained as discussed above with reference to block 430 of FIG. 4.

Upon the advertiser's approval, processing continues to block 540 where the publishing of the advertisement/content combination is enabled. As discussed more fully above, publishing of the advertisement/content combination may include publication on the platform's website server 118 or on third-party website server 107.

Processing then continues to block 550 where the revenue generated by the publication is determined. As discussed more fully above, the revenue generated by the publication may be determined by tracking activity associated with the published advertising/content combination. At block 560, a portion of the revenue for the publication is provided to the content owner. This portion of the revenue may be provided as discussed above.

The above processes enable a content owner to select various advertisements for publication with their content, contingent upon advertiser approval. However, the invention is not constrained to this approach, and other mechanisms are also available to enabling advertisements and content to be brought together. For example, in another embodiment, an advertiser might provide a solicitation for content that satisfies pre-defined criteria. For instance, an advertiser may seek to have an advertisement be combined with content that features, or compliments a given product or service. The advertiser might then announce a contest, or request for content that satisfies the pre-defined criteria. The content owners may then provide the content, which the advertiser may then select from for combining with their advertisement. In one embodiment, the advertiser might merely provide a set of rules, the pre-defined criteria, or the like, and request content that the content owners believe may satisfy such rules, criteria, or the like. In another embodiment, the advertiser might provide an advertisement, in addition, or in place of the rules, criteria, or the like, and request content be submitted for evaluation.

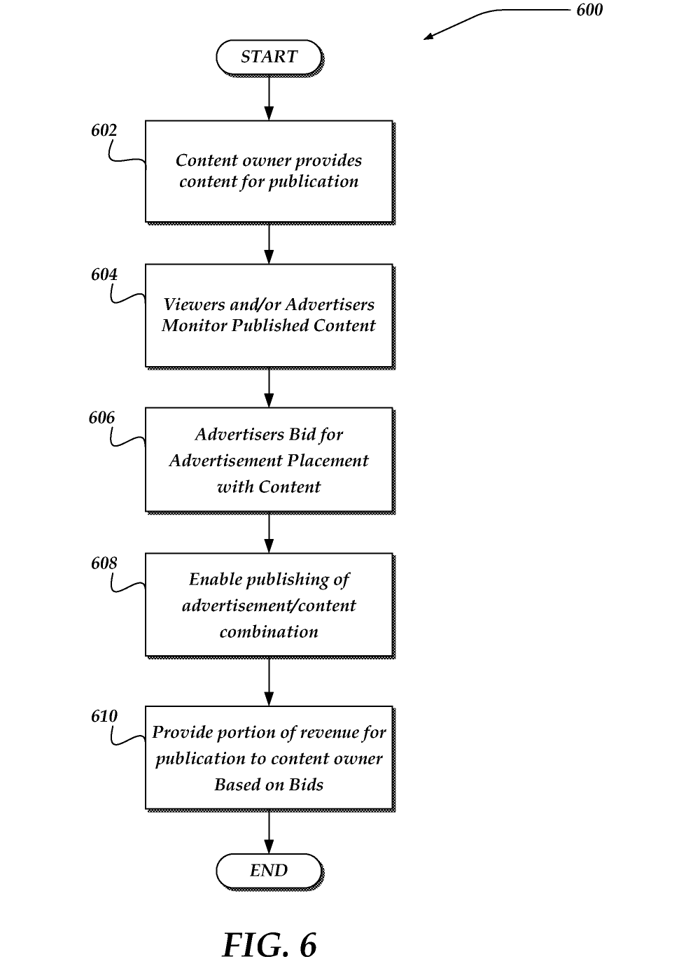

However, FIG. 6 provides yet another embodiment of another process useable to combine advertisements with content through a bidding process. Thus, as illustrated, process 600 of FIG. 6 begins, after a start block, where a content owner may provide content for publication. The content may be, as described above, virtually any form of content, including a video, graphic, audio file, or the like. The content may be published for review by a plurality of viewers. In one embodiment, the viewers may be enabled to comment on the content, vote on the content, or the like. In one embodiment, a number of times the content is viewed might be measured. Other metrics about the published content may also be obtained.

Moving to block 604, various advertisers might monitor the published content, monitor the metrics, and the like. In one embodiment, the advertisers might agree to review the content when a metric exceeds a defined threshold. For example, in one embodiment, when a content item has been reviewed by over a certain number of different viewers over a given time period, the advertiser might agree to then evaluate the content. In this manner, advertisers need not be inundated with content that might have little or no potential marketing value. For example, content that has demonstrated little viewing interest might have little marketing value. Thus, unlike situations where the advertisers might be expected to support or sponsor content of unknown marketing potential, using a threshold rating mechanism as described herein, advertisers may employ their limited resources more effectively, and/or efficiently.

Moving to block 606, given various criteria from the advertisers, including, but not limited to a popularity of the content, how compatible the content might be to a given advertisement, product/service, or the like, one or more advertisers may then bid on the published content. Based on bidding rules, and the like, one or more advertisers may then successfully be enabled to have their advertisement combined with the content.

At block 608, the content may be combined with the identified advertisement(s) from block 606, such that the combination may then be published for continued viewing. In one embodiment, where the content is published with the advertisement(s) may be defined by the advertiser and/or the content owner.

Process 600 then moves to block 610, where the content owner may then receive revenue based on the bidding results of block 606. Processing then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative User Interfaces

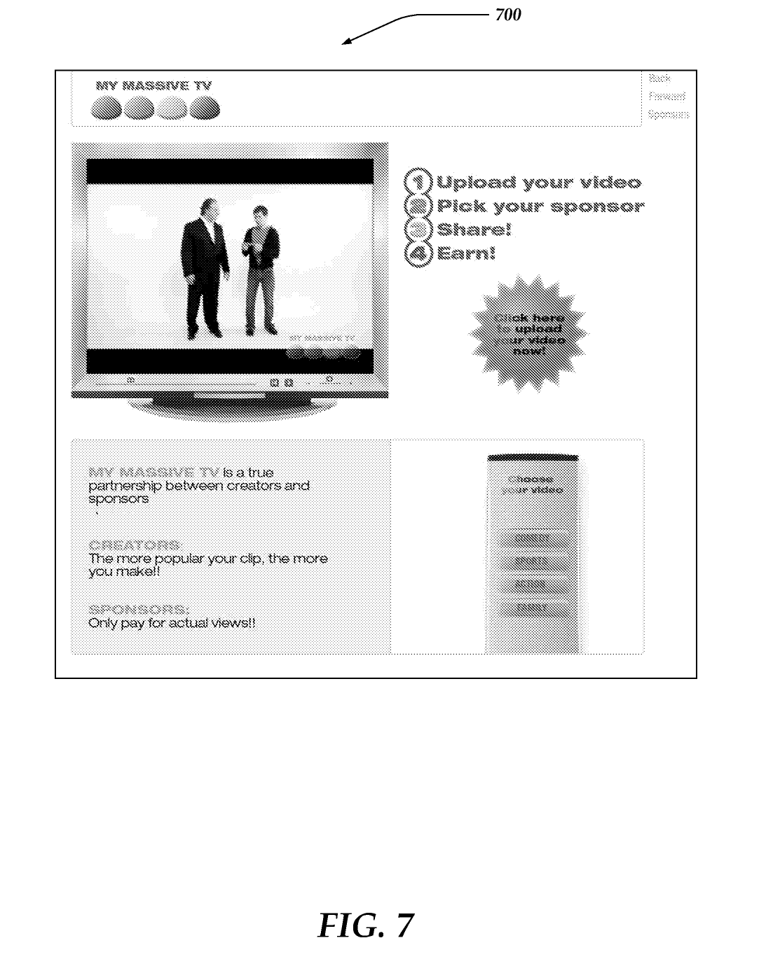

Illustrative user interfaces of certain aspects of the invention will now be described with respect to FIGS. 7-10. It should be noted that FIGS. 7-10 are provided for illustrative purposes as one possible set of interfaces to the invention. However, the invention is not to be construed as being constrained to merely these non-exhaustive examples, and other layouts, arrangements of components, colors, text, or the like, may be used, without departing from the scope of the invention.

FIG. 7 is a screenshot depicting an embodiment of a webpage for practicing the present invention. Screenshot 700 shows one possible non-exhaustive approach for providing a user of the invention with links to an advertiser interface, a content owner interface, an audience interface, and/or the like.

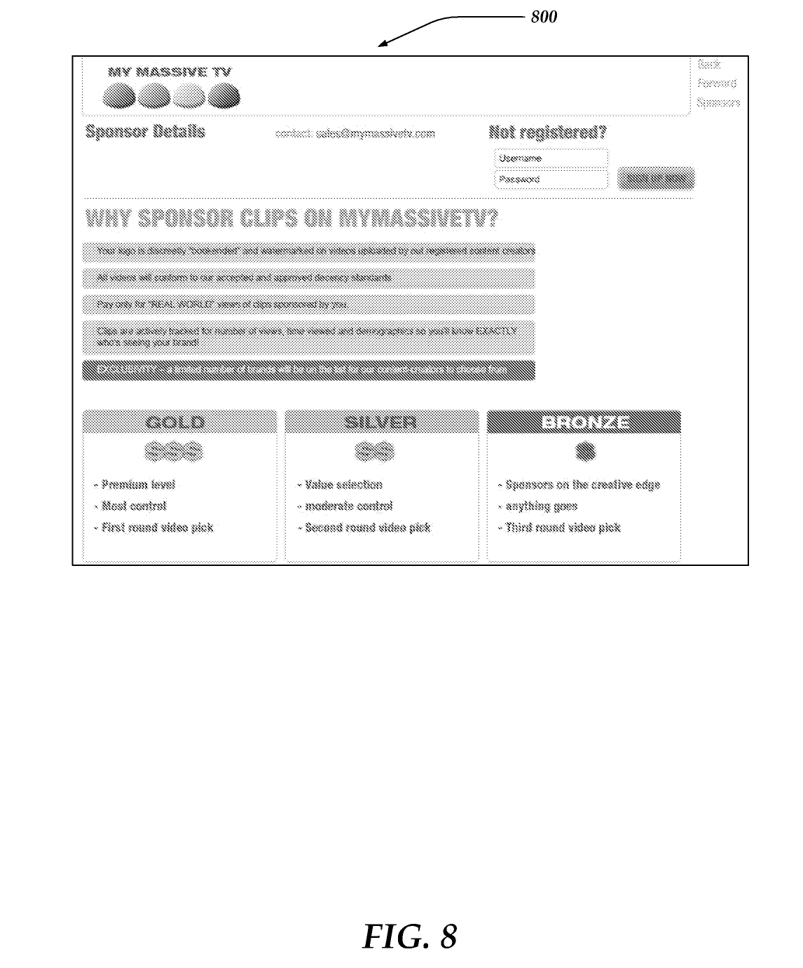

FIG. 8 is a screenshot 800 depicting an embodiment of an advertiser interface. In certain embodiments, the advertiser interface describes advertiser benefits. In one embodiment, selection of an advertiser interface link from screenshot 700 may redirect the user to screenshot 800. In some embodiments, the advertiser interface also enables an advertiser to upload advertisements, approve content for sponsorship, review performance of sponsored content, change sponsorship of content, define sponsorship criteria, and/or the like.

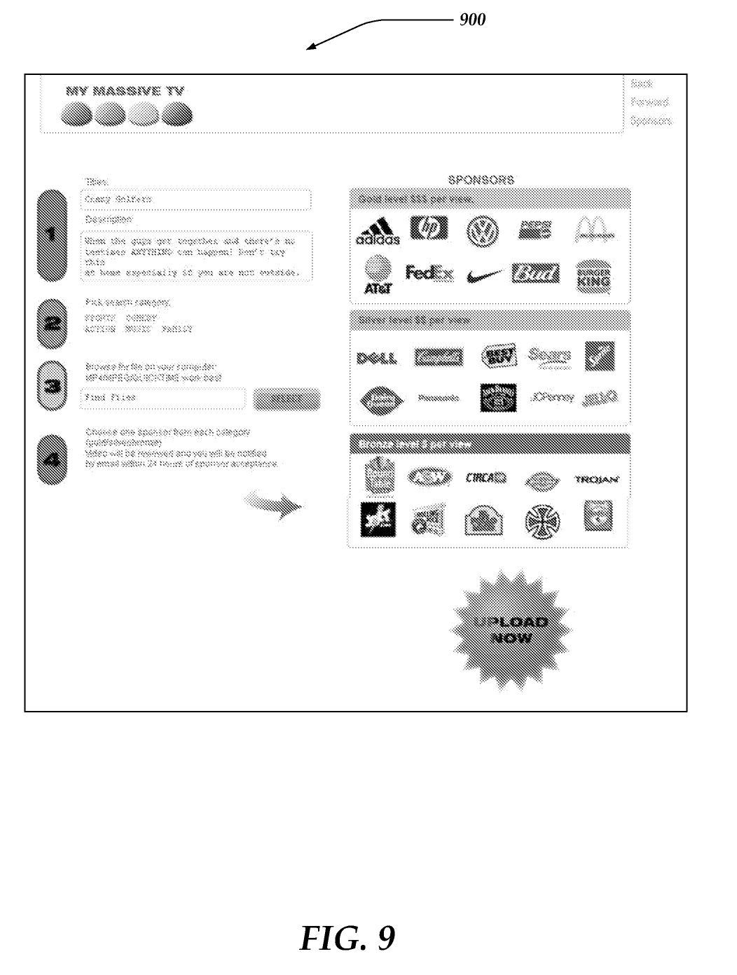

FIG. 9 is a screenshot 900 depicting an embodiment of a content owner interface. As shown, a content owner can select, name, describe, categorize, and upload content. In addition, a content owner may select potential advertisers from suggested advertisers. In other embodiments, a content owner may specify additional criteria by which potential advertisers are selected.

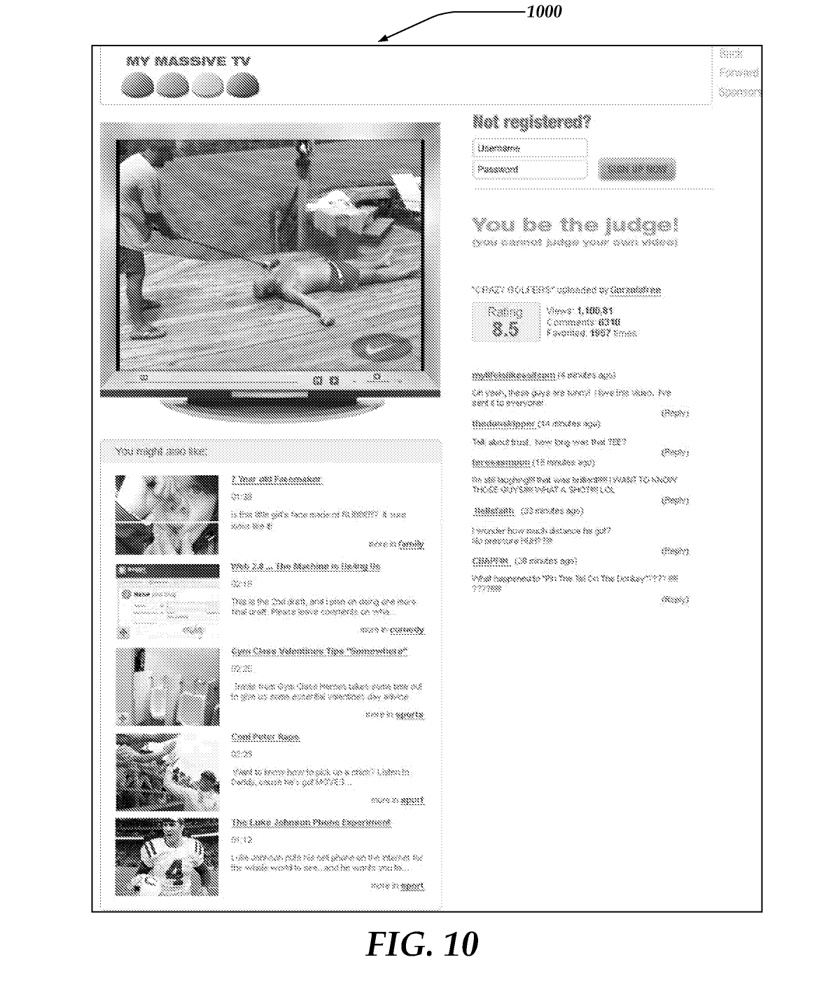

FIG. 10 is a screenshot 1000 depicting an embodiment of an audience interface through which content is published. As illustrated, the audience interface includes a video playback area, suggested videos, a login interface, comment interface, a video rating interface, and/or the like.

The above specification, examples, and data provide a description of the method and applications, and use of the invention. Since many embodiments of the invention can be made without departing from the spirit and scope of the invention, this specification merely set forth some of the many possible embodiments for the invention.

What is claimed as new and desired to be protected by Letters Patent of the United States is:

1. A method for providing advertising revenue to an owner of online content over a network, comprising:
uploading content from a content owner;
uploading a plurality of advertisements from a plurality of different advertisers;
receiving from the content owner selection of one or more advertisements for use with the uploaded content;
receiving from an advertiser associated with the selected one or more advertisements, an approval for combining the one or more advertisements with the uploaded content; and
combining the one or more advertisements with the uploaded content;
publishing the combination of one or more advertisements with the uploaded content such that a viewing metric is obtained based on the published combination; and
using the viewing metric to provide a portion of revenue to the content owner.

2. The method of claim 1, wherein combining the one or more advertisement further comprises providing the one or more advertisements in a bookend arrangement with the uploaded content, wherein at least one advertisement is placed before the uploaded content, and at least one other advertisement is placed after the uploaded content for viewing.

3. The method of claim 1, wherein the receiving an approval form the advertiser further comprises receiving a pre-approval for combining based on a rating of the content owner, wherein the rating is determined based on viewer inputs about other content provided by the content owner.

4. The method of claim 1, wherein at least one advertisement includes a hyperlink to an advertiser's promotional site on the network.

5. The method of claim 1, wherein combining the one or more advertisements with the uploaded content further comprises, inserting a watermark or other symbol into uploaded content, wherein the watermark or other symbol identifies an advertiser associated with the at least one advertisement.

6. The method of claim 1, wherein the portion of revenue is determined based at least one a number of click through actions detected.

7. The method of claim 1, wherein the content owner is enabled to select the one or more advertisements based on at least one of a recommendation from an advertiser associated with the one or more advertisements.

8. A network device configured to online advertisement activities over a network, comprising:
a transceiver to send and receive data over a network; and
a processor that is operative to perform actions, comprising:
publishing video content to a web page for viewing by a plurality of viewers;
determining viewing metrics for the published video content;
enabling a plurality of advertisers to bid on the published video content based on the viewing metrics;
based on a result of the bidding, combining at least one advertisement with the published video content;
publishing the combined at least one advertisement with the video content, such that viewers are provided with the combination of advertisement and video content; and
providing a content provider of the video content revenue based on the bidding and a metric from a viewing of the combination of the at least one advertisement and the video content.

9. The network device of claim 8, wherein enabling a plurality of advertisers to bid on the published video content is based on a viewing metric exceeding a predefined threshold.

10. The network device of claim 8, wherein at least one of the plurality of advertisers pre-selects content for bidding based at least one a reputation of the content provider.

11. The network device of claim 8, wherein advertisers within the plurality of advertisers are grouped based on at least one of a fee structure, a pre-approval process agreement, or an advertisement feature.

12. The network device of claim 8, wherein the processor is operative to perform actions, further comprising:
if a result of the bidding indicates no advertiser selects to bid for combining at least one advertisement with the published video content, publishing the video content again, independent of a combined advertisement.

13. The network device of claim 8, wherein the published video content is further modified to include at least one watermark associated with an advertiser.

14. The network device of claim 8, wherein the metric from a viewing of the combination further comprises at least one of a click-through, or a number of mouse-overs.

15. A processor readable storage medium that includes data and instructions, wherein the execution of the instructions on a computing device provides for managing online advertisement activities over a network by enabling actions, comprising:
receiving from each of a plurality of different advertisers, at least one advertisement;
receiving content from a content owner;
receiving a selection of at least one advertisement for use with the content;
based on an approval from an advertiser associated with the selected at least one advertisement, combining the content with the at least one advertisement, wherein a watermark associated with the advertiser is inserted in the content;
publishing the combined content and at least one advertisement for viewing by a plurality of viewers over the network; and
providing a revenue to the content owner based on a metric associated with the viewing of the combined content and at least one advertisement.

16. The processor readable storage medium of claim 15, wherein the approval from an advertiser further comprises a pre-approval to combine the content based on a rating of the content owner by the plurality of viewers and further another rating by a plurality of advertisers.

17. The processor readable storage medium of claim 15, wherein combining the at least one advertisement with the content further comprises placing at least one advertisement near a beginning of the content, and another advertisement near an end of the content.

18. The processor readable storage medium of claim 15, wherein receiving a selection of at least one advertisement for use with the content her comprises:
providing the content for publication viewing by the plurality of viewers;
determining a metric based on viewer inputs for the content;
providing the content to the plurality of different advertisers such that the advertisers are allowed to bid on the content; and
based on a result of the bid, receiving the selection of the at least one advertisement for use with content.

19. The processor readable storage medium of claim 15, wherein receiving a select of at least one advertisement further comprises receiving from the content owner a selection based on the received advertisements from the plurality of different advertisers.

20. The processor readable storage medium of claim 15, wherein the at least one advertisement combined with the content is configured to include at least one link to an advertiser's site that is selectable by at least one of the plurality of viewers.
